(19) United States
(12) Patent Application Publication
(10) Pub. No.: US 2009/0110330 A1
(43) Pub. Date: Apr. 30, 2009

(54) SYSTEM AND METHOD OF VIEWING IMAGES OF A DEVICE

(75) Inventor: SHIH-CHANG YEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/122,543

(22) Filed: May 16, 2008

(30) Foreign Application Priority Data
Oct. 25, 2007 (CN) 200710202249.0

(51) Int. Cl. G06K 9/36

(52) U.S. Cl. 382/298

(57) ABSTRACT

An image viewing system includes a display, a memory, an image viewing unit, a resize unit and a processor. The memory is configured for storing the images. Each image acquires additional metadata about the corresponding image. A thumbnail of the corresponding image is built in the metadata. The image viewing unit includes a retrieving module and an exhibiting module. The retrieving module is configured for retrieving the thumbnails of the images. The exhibiting module is configured for exhibiting the thumbnails of the images through the display for image viewing. The processor is configured for controlling the image viewing unit and the resize unit.

### TECHNICAL FIELD

The present invention relates to an image viewing system and a method thereof, and specifically, to a system and a method for viewing images stored in an electronic device.

### BACKGROUND

A typical method of viewing images stored in an image capturing device such as a digital camera is to retrieve the images from a memory of the digital camera and then put the images into a memory buffer. The images are resized for display by a digital signal processor (DSP) of the digital camera. Finally, the images are shown in the display of the digital camera for viewing.

However, the above process is time consuming. Therefore, it is desired to provide a simple, easy way for viewing images stored in the memory of an image capturing device.

### SUMMARY

In accordance with a present embodiment, an image viewing system is provided. The image viewing system includes a display, a memory, an image viewing unit, a resize unit, and a processor. The memory is configured for storing the images. Each image acquires additional metadata about the corresponding image. A thumbnail of the corresponding image is built into the metadata. The image viewing unit includes a retrieving module and an exhibiting module. The retrieving module is configured for retrieving the thumbnails of the images. The exhibiting module is configured for exhibiting the thumbnails of the images on the display for viewing. The processor is configured for controlling the image viewing unit and the resize unit.

Other novel features and advantages will be drawn from the following detailed description of at least one preferred embodiment, when considered in conjunction with the attached drawings.

### BRIEF DESCRIPTION OF THE DRAWINGS

Many aspects of the present image viewing system and method can be better understood with reference to the following drawings. The components in the drawings are not necessarily drawn to scale, the emphasis instead being placed upon clearly illustrating the principles of the present image viewing system and method. Moreover, in the drawings, like reference numerals designate corresponding parts throughout the several views.

FIG. 1 is a functional block diagram of an image viewing system in accordance with an exemplary embodiment.

FIG. 2 is a functional block diagram of an image viewing unit of the image viewing system in FIG. 1.

FIG. 3 is a functional block diagram of a resize unit of the image viewing system in FIG. 1.

FIG. 4 is a flow chart of an image viewing method in accordance with the exemplary embodiment.

FIG. 5 is a flow chart for displaying a thumbnail of an image in accordance with the exemplary embodiment.

### DETAILED DESCRIPTION OF THE PREFERRED EMBODIMENTS

Embodiments of the present image viewing system and method will now be described in detail below and with reference to the drawings.

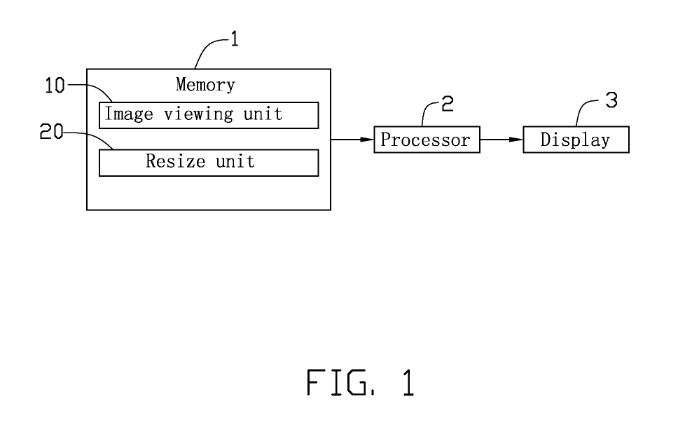

Referring to FIG. 1, a functional block diagram of an image viewing system in a present embodiment of this invention is shown. The image viewing system can be applied in, for example, a digital camera. The image viewing system includes a memory 1, a processor 2, and a display 3.

The display 3 includes a buffer configured for storing thumbnails of images to be displayed by the display 3. Each of the thumbnails has a resolution suitable for the display 3. The memory 1 is configured for storing images, an image viewing unit 10, and a resize unit 20. The images are captured by the digital camera or obtained by other methods and stored in the memory 1. Each image acquires additional metadata about the image. The metadata is in an exchangeable image file format (EXIF). A thumbnail of the image is built into the metadata of the corresponding image.

The processor 2 is configured for controlling the image viewing unit 10 and the resize unit 20. The processor 2 controls the image viewing unit 10 to facilitate the display 3 to show the thumbnails corresponding to the images stored in the memory 1. The resize unit 20 is configured for copying images from the memory 1 and changing the resolution thereof to create corresponding thumbnails of the images.

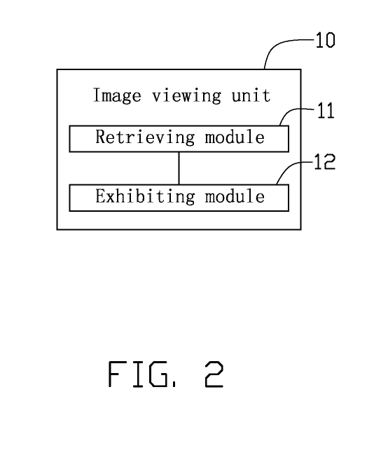

Referring to FIG. 2, a functional block diagram of the image viewing unit 10 in accordance with the present embodiment is shown. The image viewing unit 10 includes a retrieving module 11 and an exhibiting module 12. The retrieving module 11 is configured for retrieving the thumbnail built into the metadata of the image stored in the memory 1. The exhibiting module 12 is configured for exhibiting the thumbnail of the image through the display 3 for viewing.

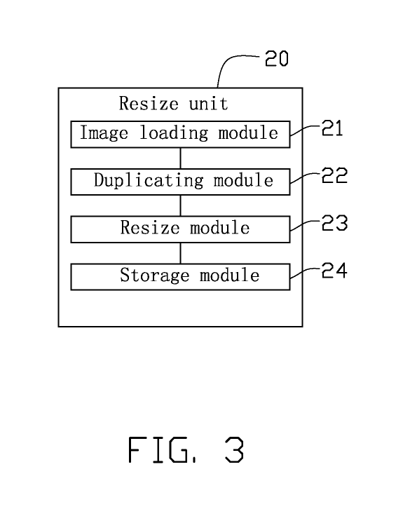

Referring to FIG. 3, a functional block diagram of the resize unit 20 according to the present embodiment of this invention is shown. The resize unit 20 includes an image loading module 21, a duplicating module 22, and a resize module 23, and a storage module 24. The image loading module 21 is configured for loading one of the images from the memory 1 of the digital camera. The duplicating module 22 is configured for duplicating the loaded image. The resize module 23 is configured for copying images from the memory 1 and changing the resolution thereof to create corresponding thumbnails of the images. The resolution of the thumbnail is suitable for the display 3.

The storage module 24 is configured for including the thumbnail in the metadata of the image loaded by the image loading module 21. For example, in a first embodiment of the invention, the memory 1 stores a portrait with a resolution of 1280*960. The portrait is loaded by the image loading module 21 and then duplicated by the duplicating module 22. If the resolution of the display 3 is 320*240, accordingly, the duplicated portrait is resized by the resize module 23 to create a thumbnail with a resolution of 320*240. Then, the thumbnail is included in the metadata corresponding to the portrait is 320*240.

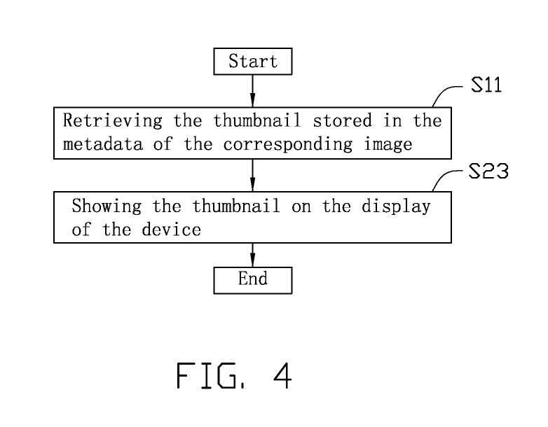

Referring to FIG. 4, a flow chart of an image viewing method according to the present embodiment is shown. The method includes:

STEP S11: retrieving the thumbnail stored in the metadata of the corresponding image.
STEP S23: showing the thumbnail on the display of the device.

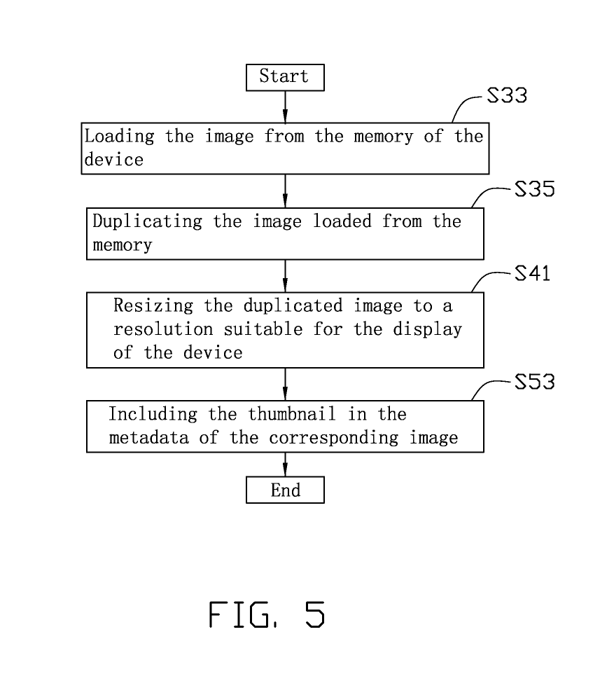

Referring to FIG. 5, a method for creating the thumbnail of the image is shown. The method includes:

STEP S33: loading the image from the memory of the device.
STEP S35: duplicating the image loaded from the memory.
STEP S41: resizing the duplicated image to a resolution suitable for the display of the device.
STEP S53: including the thumbnail in the metadata of the corresponding image.

Compared to conventional arts, the exemplary embodiment directly retrieves the thumbnails of the images stored in the memory of the device for viewing. It avoids image processing during image viewing and thus saves time.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An image viewing system configured for viewing images, each one of the images acquiring additional metadata about the image, the image viewing system comprising:
a display;
a memory configured for storing the images, each of the images comprising a thumbnail stored in the metadata of the respective image,
an image viewing unit including a retrieving module and an exhibiting module, the retrieving module being configured for retrieving the thumbnail of the image; the exhibiting module being configured for exhibiting the thumbnail of the images on the display; and
a processor configured for controlling the image viewing unit.

2. The image viewing system as claimed in claim 1, wherein a resolution of the thumbnail is suitable for the display.

3. The image viewing system as claimed in claim 1, wherein the resolution is identical to that of the display.

4. The image viewing system as claimed in claim 1, wherein the image viewing system further includes a resize unit configured for creating the thumbnail of the corresponding image.

5. The image viewing system as claimed in claim 4, wherein the image viewing unit and the resize unit are stored in the memory.

6. The image viewing system as claimed in claim 4, wherein the resize unit includes an image loading module, a duplicating module, and a resize module, and a storage module; the image loading module being configured for loading one of the images; the duplicating module being configured for duplicating the image loaded by the image loading module; the resize module being configured for creating a corresponding thumbnail of the duplicated image; the storage module being configured for storing the thumbnail to the metadata of the image.

7. An image viewing method for viewing images stored in a device, the method comprising:
creating a thumbnail of one of the images;
retrieving the thumbnail stored in the metadata of the corresponding image; and
showing the thumbnail on the display of the device.

8. The image viewing method as claimed in claim 7, wherein creating the thumbnail of the image includes:
loading the image from the memory of the device;
duplicating the image loaded from the memory;
resizing the duplicated image to a resolution identical to that of the display of the device; and
storing the thumbnail to the metadata of the corresponding image.
